(19) United States
(12) Patent Application Publication
(10) Pub. No.: US 2011/0262232 A1
(43) Pub. Date: Oct. 27, 2011

(54) Lathe blade assembly

(76) Inventor: Chin-Chiu Chen, Cingshuei Chen (TW)

(21) Appl. No.: 12/799,391

(22) Filed: Apr. 23, 2010

(51) Int. Cl. B23B 27/08; B23B 27/16

(52) U.S. Cl. 407/46; 407/47

(57) ABSTRACT

The lathe blade assembly has a body, a head and a bolt. The body has a head mount having an outer diameter and an outer periphery surface. The head has a mounting recess mounted around the head mount, and having an inner diameter and an inner periphery surface. The inner diameter of the mounting recess, wherein the inner diameter is smaller than the outer diameter before the head is mounted on the head mount. The inner periphery surface of the mounting recess is attached to and pressed onto the outer periphery surface of the head mount securely. The bolt is mounted through the head and screwed into the head mount to connect the body and head.

### BACKGROUND OF THE INVENTION

1. Field of the Invention

The present, invention relates to a lathe blade, and more particularly to a lathe blade assembly with a head mounted on a body securely by thermal expansion or cool shrinking.

2. Description of Related Art

A convention blade for a lathe is set on a shaft of the lathe and has a body, a head and a bolt. The body is cylindrical, and has a front end and a head mount. The head mount is cylindrical, is formed on and protrudes from the front end of the body and has an outer diameter and a threaded hole formed in the head mount. The head is mounted on the head mount of the body, and has an inner end, an outer end, a mount recess, a countersink, a through hole and multiple blades.

The mount recess is formed in the inner end of the head and has an inner diameter larger than the outer diameter of the head mount to hold the head mount. The countersink is formed in the outer end of the head. The through hole is formed through the head and aligns with the mount recess and the countersink. The blades are mounted on and arranged around the outer end of the head. The bolt is arranged in the countersink of the head, mounted through the through hole of the head and screwed into the threaded hole of the body to connect the head of the body.

However, because the inner diameter of the mount recess of the head is larger than the outer diameter of the head mount of the body, the head recess of the head is mounted on the head mount of the body loosely. When the knife is set on the shaft of the lathe and turned at a high speed, the head and the body will knock against with each other and manufacturing quality is reduced.

To overcome the shortcomings, the present invention tends to provide a lathe blade assembly to mitigate or obviate the aforementioned problems.

### SUMMARY OF THE INVENTION

The main objective of the present invention is to provide a lathe blade assembly with a head mounted on a body securely by thermal expansion or cool shrinking.

The lathe blade assembly has a body, a head and a bolt. The body has a head mount having an outer diameter and an outer periphery surface. The head has a mounting recess mounted around the head mount, and having an inner diameter and an inner periphery surface. The inner diameter of the mounting recess, wherein the inner diameter is smaller than the outer diameter before the head is mounted on the head mount. The inner periphery surface of the mounting recess is attached to and pressed onto the outer periphery surface of the head mount securely. The bolt is mounted through the head and screwed into the head mount to connect the body and head.

Other objects, advantages and novel features of the invention will become more apparent from the following detailed description when taken in junction with the accompanying drawings.

### BRIEF DESCRIPTION OF THE DRAWINGS

FIG. 1 is a perspective view of a lathe blade assembly in accordance with the present invention;

FIG. 2 is an exploded perspective view in partial section of the lathe blade assembly in FIG. 1;

FIG. 3 is an exploded side view in partial section of the lathe blade assembly in FIG. 1; and

FIG. 4 is a side view in partial section of the lathe blade assembly in FIG. 1.

### DETAILED DESCRIPTION OF PREFERRED EMBODIMENT

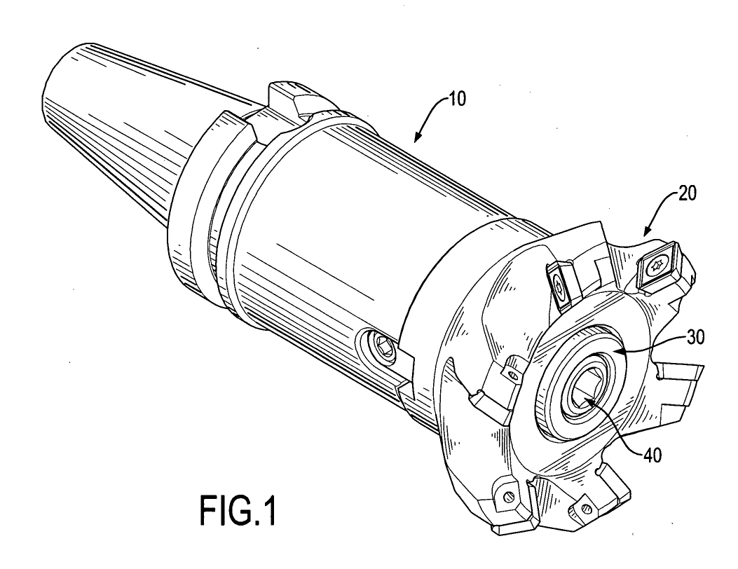

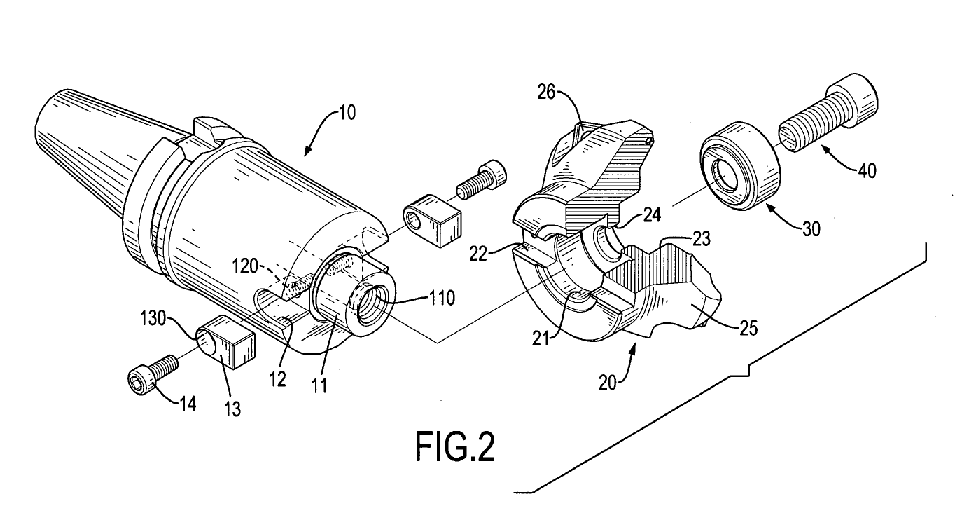

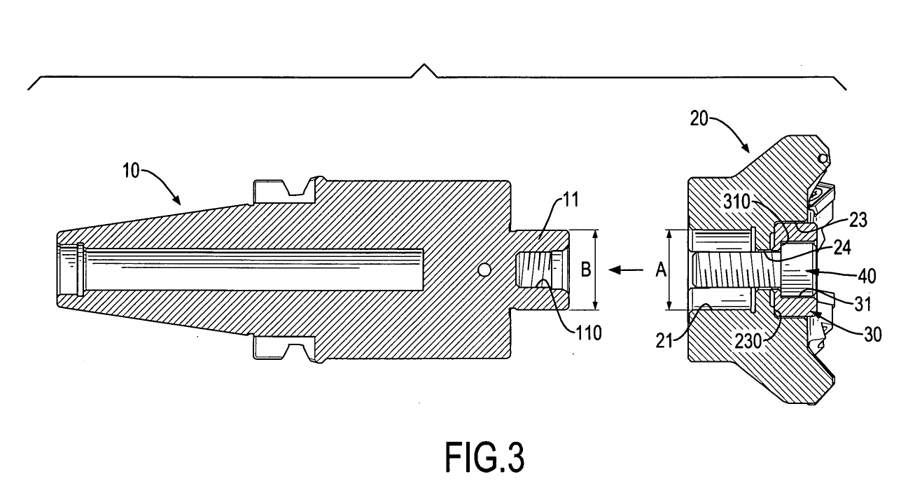

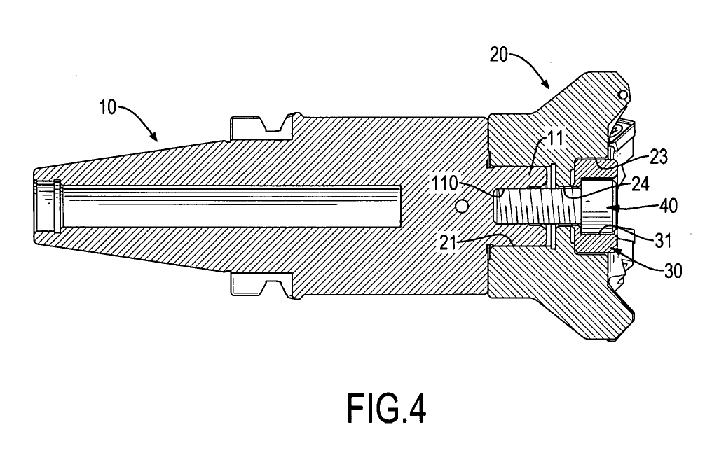

With reference to FIGS. 1 to 4, a lathe blade assembly for a lathe in accordance with the present invention is set on a shaft of the lathe and has a body (10), a head (20), a cap (30) and a bolt (40).

The body (10) is cylindrical and has a front end, a head mount (11), two positioning recesses (12), two positioning blocks (13) and two screws (14). The head mount (11) is cylindrical, is formed on and protrudes from the front end of the body (10) and has an outer diameter (B), an outer periphery surface and a threaded hole (110). The threaded hole (110) is formed in the head mount (11). The positioning recesses (12) are respectively radially formed in the front end of the body (10) and respectively have an inner surface and a screwing hole (120) formed in the inner surface of the positioning recess (12) of the body (10).

The positioning blocks (13) are respectively mounted in the positioning recesses (12) and extend out the front end of the body (10). Each positioning block (13) has a through hole (130) aligning and communicating with the screwing hole (120) of the corresponding positioning recess (12). The screws (14) are respectively mounted through the through holes (130) of the positioning blocks (13) and screwed into the screwing holes (120) of the positioning recesses (12) to fix the positioning blocks (13) on the body (10).

The head (20) is mounted around the head mount (11) of the body (10) and has an inner end, an outer end, a mounting recess (21), two positioning grooves (22), a containing recess (23), a bolt hole (24), multiple blade mounts (25) and multiple blades (26). The mounting recess (21) is formed in the inner end of the head (20), and has an inner diameter (A) and an inner periphery surface. The inner diameter (A) of the mounting recess (21) is smaller than the outer diameter (B) of the head mount (11) before the head (20) is mounted on the head mount (11) of the body (10). The inner periphery surface of the mounting recess (21) is defined in the mounting recess (21) and is attached to and pressed onto the outer periphery surface of the head mount (11) securely.

The positioning grooves (22) are radially formed in the inner end of the head (20), communicate with the mounting recess (21) and are respectively mounted around the positioning blocks (13). The containing recess (23) is formed in the outer end of the head (20) and has an annular flange (230) formed on the bottom of the containing recess (23). The bolt hole (24) is formed through the head (20) and communicates with the mounting recess (21) and the containing recess (23). The blade mounts (25) are arranged around the outer end of the head (20). The blades (26) are respectively mounted on the blade mounts (25).

The cap (30) is mounted in the containing recess (23) of the head (20), abuts the annular flange (230) and has a countersink (31) formed in the cap (30) and facing the outer end of the head (20). The countersink (31) has a bottom rim (310) formed around an inner side of the countersink (31).

The bolt (40) is mounted through the cap (30) and the head (20) and screwed into the head mount (11) of the body (10) to connect the cap (30) and the head (20) with the body (10). The bolt (40) has a bolt head and a threaded section. The bolt head of the bolt (40) is contained in the countersink (31) and abuts the bottom rim (310). The threaded section of the bolt (40) is mounted through the cap (30), the bolt hole (24) and the mounting recess (21) of the head (20) and is screwed into the threaded hole (110) of the head mount (11).

The head (20) is mounted on the body (10) using temperature differential mounting. The temperature differential mounting may be achieved by heating the head (20) before the head (20) is mounted on the body (10). The head (20) is heated to make the mounting recess (21) expand. The expanded inner diameter (A) of the mounting recess (21) is larger than the outer diameter (B) of the head mount (11) of the body (10), such that the head mount (11) of the body (10) can be inserted into the mounting recess (21) of the head (20). After the head (20) is cooled down due to normal atmospheric temperature, the inner diameter (A) of the mounting recess (21) returns to an original size. Consequently, the inner periphery surface of the mounting recess (21) is attached to and pressed onto the outer periphery surface of the head mount (11) securely. The head (20) is held on the head mount (11) of the body (10) steady.

Alternatively, the temperature differential mounting may be achieved by cooling the body (10). The body (10) is cooled to make the head mount (11) shrink by liquid nitrogen. The reduced outer diameter (B) of the head mount (11) is smaller than the inner diameter (A) of the mounting recess (21) of the head (20), so that the head mount (11) of the body (10) can be inserted into the mounting recess (21) of the head (20). The outer diameter (B) of the head mount (11) will expand to an original size after a specific term due to normal atmospheric temperature. Accordingly, the head (20) is held on the head mount (11) of the body (10) firmly.

Further, both the head (20) may be heated and the body (10) may be cooled to achieve sufficient metal thermal expansion and contraction for the temperature differential mounting. The head mount (11) of the body (10) is mounted in the mounting recess (21) of the head (20) securely by the temperature differential mounting. The lathe blade assembly securely connects the body (10) and the head (20) is easy to manufacture, and provides high quality products.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A lathe blade assembly comprising:
a body having
a front end;
a head mount formed on and protruding from the front end of the body and having
an outer diameter;
an outer periphery surface; and
a threaded hole formed in the head mount;
a head mounted around the head mount of the body and having
an inner end;
an outer end;
a mounting recess formed in the inner end of the head and having
an inner diameter, wherein the inner diameter of the mounting recess is smaller than the outer diameter of the head mount before the head is mounted on the head mount of the body; and
an inner periphery surface defined in the mounting recess and attached to and pressed onto the outer periphery surface of the head mount securely;
a containing recess formed in the outer end of the head; and
a bolt hole formed through the head and communicating the mounting recess and the containing recess;
a cap mounted in the containing recess of the head and having a countersink formed in the cap and faced the outer end of the head; and
a bolt mounted through the cap and the head, and screwed into the head mount of the body and having
a bolt head contained in the countersink; and
a threaded section mounted through the cap, the bolt hole and the mounting recess, and screwed into the threaded hole of the head mount.

2. The lathe blade assembly as claimed in claim 1, wherein
the body further has
two positioning recesses respectively radially formed in the front end of the body, and respectively having a screwing hole;
two positioning blocks respectively corresponding to and mounted in the positioning recesses, and extending out the front end of the body, and each having a through hole aligned and communicated to the screwing hole of the corresponded positioning recess; and
two screws respectively mounted through the through holes of the positioning blocks, and screwed into the screwing holes of the positioning recesses to fix the positioning blocks on the body; and
the head further has two positioning grooves radially formed in the inner end of the head, and respectively corresponding to and mounted on the positioning blocks.

3. The lathe blade assembly as claimed in claim 2, wherein the head further has
multiple blade mounts arranged around the outer end of the head; and
multiple blades respectively mounted on the blade mounts.
